(19) United States
(12) Patent Application Publication
(10) Pub. No.: US 2026/0350470 A1
(43) Pub. Date: Nov. 5, 2026

(54) MACHINE LEARNING SYSTEMS TO IDENTIFY DATA DRIFT FOR MACHINE-LEARNING MODELS TRAINED TO GENERATE PREDICTIONS AND RECOMMENDATIONS

(71) Applicant: Allvest Information Services, Inc., Bountiful, UT (US)

(72) Inventors: Sean B.D. Hosman, Nashville, TN (US); Casey L. Riley, Middleton, ID (US); Marjorie K. Rist, Nashville, TN (US); Benjamin P. Snell, Meadow, UT (US)

(73) Assignee: Allvest Information Services, Inc., Bountiful, UT (US)

(21) Appl. No.: 19/662,493

(22) Filed: Apr. 29, 2026

Related U.S. Application Data
(60) Provisional application No. 63/797,474, filed on Apr. 30, 2025.

(51) Int. Cl. G06N 20/00

(52) U.S. Cl. CPC G06N 20/00

(57) ABSTRACT

A method can include: receive a historical data set, extract feature vectors from the historical data set corresponding to the input features for the historical recidivism model, split the feature vectors into a training set and a test set, generate candidate machine-learning models by executing machine-learning algorithms using as input the training set, calculate a relative accuracy of the recidivism model and the candidate machine-learning models using an error rate for the recidivism model and error rates of the candidate machine-learning models, determine a drift based on a difference between a feature importance of the input features for the recidivism model and a feature importance of the input features for the candidate machine-learning models, and in response to the drift exceeding a predetermined drift threshold and/or the relative accuracy being below a predetermined accuracy threshold, generate an alert including the drift and the relative accuracy.

### CROSS-REFERENCE TO RELATED APPLICATIONS

This application claims priority to U.S. Provisional Application No. 63/797,474, filed Apr. 30, 2025, which application is incorporated herein by reference in its entirety.

### BACKGROUND

Machine-learning models for generating predictions and recommendations are trained using datasets including historical performance and outcome data. The historical performance and outcome data, and thus the training of the machine-learning models, may not accurately reflect current relationships between data features of a subject of interest. Changes in input data such as changes in regulation or changes in peers of the subject of interest can degrade an accuracy of machine-learning models and are referred to as data drift.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing.

FIG. 1 is an illustration of an example system for generating prescriptive recommendations.

FIG. 2 is an illustration of an example system for identifying data drift for the system of FIG. 1.

FIG. 3 is a flow diagram of an example method for identifying data drift in input data.

FIG. 4 is an illustration of an example system for comparing a machine-learning model with a drift comparison model.

FIG. 5 is a flow diagram of an example method for identifying model drift.

FIG. 6 is an illustration of an example computing device.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

Predictive models have become widely utilized across numerous domains to analyze historical data and forecast future outcomes. These models may process large volumes of data to identify patterns and correlations that can inform decision-making processes. In some aspects, predictive models are deployed in healthcare settings to anticipate patient outcomes, disease progression, or treatment efficacy. Financial institutions may use predictive models to assess credit risk, detect fraudulent transactions, or forecast market trends. Insurance providers can employ such models to evaluate risk profiles and determine appropriate coverage terms. Weather forecasting systems may rely on predictive models to anticipate atmospheric conditions and severe weather events. Manufacturing operations can utilize predictive models for quality control, demand forecasting, and predictive maintenance of equipment. In some cases, predictive models are applied in transportation and logistics to optimize routing and resource allocation. From a societal standpoint, an important application of predictive models is in the correctional system, where such models may be used to assess individuals involved with public safety agencies and inform decisions related to supervision, rehabilitation, and resource allocation.

For over forty years, public safety agencies around the world have used predictive models to assess individuals involved with correctional systems. Many of these models were developed using localized datasets based on societal norms and conditions relevant to the time of their creation. These models then are made operational traditionally by creating a human interface that has a person collect responses to questions via paper and pencil or in some cases by forms that collect a digital response to a question on a computer. In both cases those responses are what is used as inputs for scoring. The predictive science behind the model then is laid out in a scoring guide which explains to the assessor (the person responsible for scoring the assessment) how to analyze the responses to come up with whatever “score” represents the prediction they are to use. Again, a computer can also do the work of the assessor. Many agencies across the US still use a paper and pencil approach which can be connected to some form of computer system.

The effectiveness of a model's prediction depends heavily on the ability to collect data in a standardized way so that the quality and sometimes the quantity of the data (or features) available are consistent. This operationalization of collecting data for input into a model is no different than the process of actually getting data collected for training a model, and in fact, all the data inputs are usually present during training with the addition of what we would call the outcome or target feature. The outcome data or target feature is what assessors want the model to predict based on the data inputs. During training, quality data, characterized by its accuracy, completeness, relevance, and timeliness, enables the model to learn meaningful patterns and relationships, leading to more precise and reliable predictions. Conversely, low-quality data, which may contain errors, inconsistencies, or irrelevant information, can introduce noise and bias into the model, hindering its ability to generalize, and ultimately degrading the accuracy of its predictions. Moreover, even high-quality data represents a snapshot in time, where correlations between data captured by models and populations reflected in the data used by models can shift over time, degrading accuracy of the models.

Implementations and embodiments discussed herein solve the technical problem of detecting and explaining data drift. By generating a new machine-learning model and comparing the new machine-learning model to a historic, target model, a relative accuracy of the target model as well as data drift can be identified and evaluated. The data drift can be evaluated as a change in feature importance over time, or between the target model and the new machine-learning model. The relative accuracy and data drift can be determined by gathering a current dataset, splitting the dataset into a training set and a test set, training the new machine-learning model using the training set, and executing the target model and the new machine-learning model using the test set to determine error rates and feature importance of input features for the target model and the new machine-learning model. The error rates are used to determine the relative accuracy of the target model and the new machine-learning model to evaluate a degradation of accuracy of the target model, and the feature importance of input features for the target model and the new machine-learning model are used to determine changes in feature importance for the two models, indicating data drift. The data drift can be correlated with the accuracy degradation to explain the accuracy degradation. The new machine-learning model can be used as a basis for future predictions, improving model accuracy. In this way, data drift can be automatically detected, evaluated, and mitigated, preventing inaccurate predictions due to outdated models.

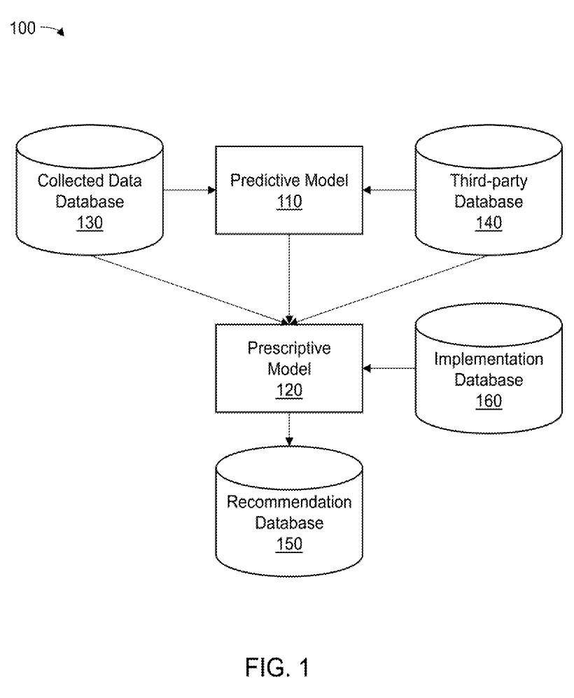

FIG. 1 is an illustration of an example system 100 for generating prescriptive recommendations for incarcerations. The system 100 includes a predictive model 110, a prescriptive model 120, a collected data database 130, a third-party database 140, and an implementation database 160.

The predictive model 110 receives, as input, data from the collected data database 130 and the third-party database 140 to generate predictions. The predictive model 110 can be a machine-learning model such as a support vector machine, a decision tree, ensemble trees, a generalized additive model, a neural network, a naïve Bayes model, a k-nearest neighbor, a discriminant analysis model, linear regression mode, a non-linear regression model, a generalized linear model, or a gaussian process regression. In some implementations, the predictive model 110 may be a Random Forest model or a penalized regression model such as LASSO (Least Absolute Shrinkage and Selection Operator), Boosted, or Ridge regression. Penalized regression models apply regularization techniques that add penalty terms to the loss function during training, which helps prevent overfitting by constraining the magnitude of model coefficients. These models are particularly useful when dealing with high-dimensional datasets where the number of features may be large relative to the number of observations, as the penalty terms encourage simpler models by shrinking less important coefficients toward zero or eliminating them entirely. In some implementations, the predictive model 110 receives as input data from additional databases and/or other sources.

The predictive model 110 may be a behavioral predictive model configured to predict human behavior and/or consequences associated with human behavior. In an example, the predictive model 110 is a behavioral predictive model configured to predict behavioral outcomes (i.e., target features). The behavioral predictive model can be a public safety model configured to predict human behavior implicating public safety. The behavioral predictive model can be a prisoner assessment model configured to predict human behavior of prisoners during and after prison sentences. Target features predicted by the behavioral predictive model can include one or more of trauma, institutional violence, risk to recidivate, risk to recidivate due to violent crime, risk to recidivate due to property crime, risk to recidivate due to drug crime, suicide risk, sex offence risk, detainment risk, abscondence risk, supervision level applied, classification level applied, and criminogenic need level applied. The behavioral predictive model can be configured to predict the one or more target features for a particular gender, and/or age range.

The predictive model 110 (e.g., behavioral predictive model) can be generated or trained to predict the target features. In an example, the predictive model 110 can be trained to generate predictions as to a likelihood of recidivism for an individual. In an example, the predictive model 110 can be trained to generate predictions as to a likelihood of an individual committing a predetermined set of crimes, or a type of crime (e.g., violent, property, drug). In an example, the predictive model 110 is trained to classify individuals into three risk groups: low risk, moderate risk, and high risk. In this example, the predictive model 110 can generate predictions for a set of target features and determine a risk group based on the predictions (e.g., scores) for the set of target features. In an example, the predictive model 110 is trained to generate a probability vector including a probability for committing each crime in a set of crimes.

The data in the collected data database 130 may be data collected from individuals, such as survey data, questionnaire data, interview data, or the like. The data in the third-party database 140 may be data collected from other sources, such as government databases, court records, employment records, health records, police reports, and other sources. The data in the collected data database 130 and the data in the third-party database 140 that are provided to the predictive model 110 as input can be referred to as “input data.” The input data to the predictive model 110 for an individual can include a set of features (e.g., one or more features). In an example, the set of features can include one or more of the following: whether the individual is in touch with positive friends, whether the individual is in touch with negative friends, whether the individual is experiencing family conflict, an education level of the individual, an employment history of the individual, a mental health history of the individual, a physical health history of the individual, an arrest history of the individual, an alcohol use history of the individual, a drug use history of the individual, and/or a self-assessment of the individual. In this example, each of the features is assigned a weight, where a weighted sum of the features is a risk score for the individual. Weights for the predictive model 110 are learned during training of the predictive model 110. The output of the predictive model 110 is provided as input to the prescriptive model 120.

The prescriptive model 120 is executed using, as input, the output of the predictive model 110 and/or data from the collected data database 130 and/or the third-party database 140 to generate prescriptive recommendations. The prescriptive model 120 can be a machine-learning model such as a support vector machine, a decision tree, ensemble trees, a generalized additive model, a neural network, a naïve Bayes model, a k-nearest neighbor, a discriminant analysis model, linear regression model, a non-linear regression model, a generalized linear model, or a gaussian process regression. In an example, risk scores for a set of individuals and the underlying data used to generate those risk scores are provided as input to the prescriptive model 120 to generate a recommendation for allocating resources to the set of individuals. The risk scores represent risks for individuals, such as recidivism risk, if no intervention is performed, or no resources are provided to the individuals. The prescriptive model 120 generates recommendations for allocating services and/or resources to the individuals in order to efficiently allocate services and/or resources to lower the risks. In an example, the predictive model 110 outputs risk scores for a set of incarcerated individuals to be released, the risk scores representing a likelihood of recidivism for each individual, and the prescriptive model 120 generates recommendations for resources to be allocated to each individual to lower the overall recidivism risk for the set of incarcerated individuals. In some implementations, the recommendations generated by the prescriptive model 120 include modified risk scores as a prediction of how the risk scores can be reduced by implementing the recommendations. The recommendations generated by the prescriptive model 120 are stored in the recommendation database 150.

The predictive model 110 can be updated based on data from the collected data database 130 and/or the third-party database 140. In an example, the predictive model 110 can be updated based on actual recidivism data from the collected data database 130 and/or the third-party database 140. In an example, the predictive model 110 generates a risk score of 90% for an individual for recidivism within 6 months if no intervention takes place, and the predictive model 110 is updated based on the individual not recidivating within 6 months despite a lack of intervention.

The prescriptive model 120 can be updated based on information from the implementation database 160 and the collected data database 130 and/or the third-party database 140. The implementation database 160 includes data on implementation of interventions, including interventions reflected in the recommendations generated by the prescriptive model 120. In an example, the prescriptive model 120 is updated based on recidivism data for individuals as well as interventions performed for those individuals. In an example, the prescriptive model 120 generates a recommendation to assign an employment specialist to an individual to reduce a recidivism risk for the individual from 80% to 20%, and the prescriptive model 120 is updated based on the individual recidivating despite the assignment of the employment specialist to the individual.

In another embodiment, the predictive model 110 may be a predictive model configured to predict equipment wear and/or outcomes associated with operation of equipment. In another embodiment, the predictive model 110 may be a predictive model configured to predict crop success and/or outcomes associated with agriculture. Other examples of predictive models can be configured to predict outcomes in other domains including, but not limited to healthcare, financial services, insurance, manufacturing, etc.

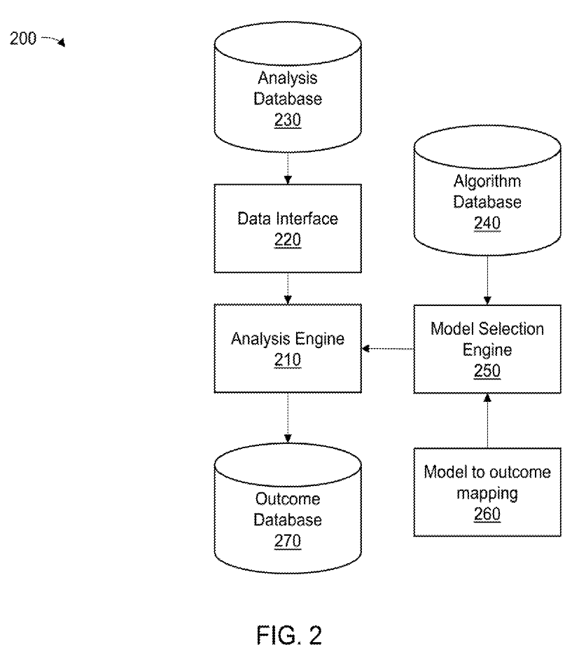

FIG. 2 is an illustration of an example system 200 for identifying data drift for the system 100 of FIG. 1. The system 200 includes an analysis engine 210, a data interface 220, an analysis database 230, an algorithm database 240, a model selection engine 250, a model to outcome mapping 260, and an outcome database 270. The system 200 operates to identify data drift for the system 100 of FIG. 1 to update the system 100 and improve an accuracy of the system 100.

The analysis database 230 includes data collected from the system 100. The analysis database 230 can include data from the collected data database 130, the third-party database 140, and the recommendation database 150, as well as predictions generated by the predictive model 110. In an aspect, the analysis database 230 includes data identified as outcome data, from the system 100. The data interface 220 allows for ingesting data from multiple sources and in multiple formats. In an example, the data interface 220 implements APIs for collecting data on individuals related to data used as input to the predictive model 110 and/or the prescriptive model 120 and/or the outputs of the predictive model 110 and/or the prescriptive model 120. In some implementations, the data interface 220 receives the data directly from components of the system 100. The data interface 220 provides the data to the analysis engine 210.

The analysis engine 210 monitors the system 100 for data drift. Specifically, the analysis engine 210 can monitor the predictive model 110 and/or the prescriptive model 120. The analysis engine 210 executes machine-learning algorithms to monitor how the output of a target model (i.e., the predictive model 110 or the prescriptive model 120) is affected by data drift.

The analysis engine 210 transforms the data received from the data interface 220 into one or more features corresponding to a set of features used by the target model (i.e., the predictive model 110 or the prescriptive model 120). The analysis engine 210 can label, tag, or otherwise identify the features based on an identification of one or more target features. The target features may correspond to predicted features. In an example, the analysis engine 210 receives an indication that recidivism is a target feature (i.e., a target output) for prediction and the analysis engine 210 labels a recidivism feature in the feature set as the target feature.

The analysis engine 210 can receive a set of algorithms from the model selection engine 250. The model selection engine 250 can use the model to outcome mapping 260 to retrieve the set of algorithms from the algorithm database 240. The algorithm database 240 can include algorithms such as a support vector machine, a decision tree, ensemble trees, a generalized additive model, a neural network, a naïve Bayes model, a k-nearest neighbor, a discriminant analysis model, linear regression mode, a non-linear regression model, a generalized linear model, or a gaussian process regression. The model to outcome mapping 260 can map target features to algorithms, or types of algorithms in the algorithm database 240. In an example, the model to outcome mapping 260 maps class-based target features to classification algorithms and continuous target features to regression algorithms.

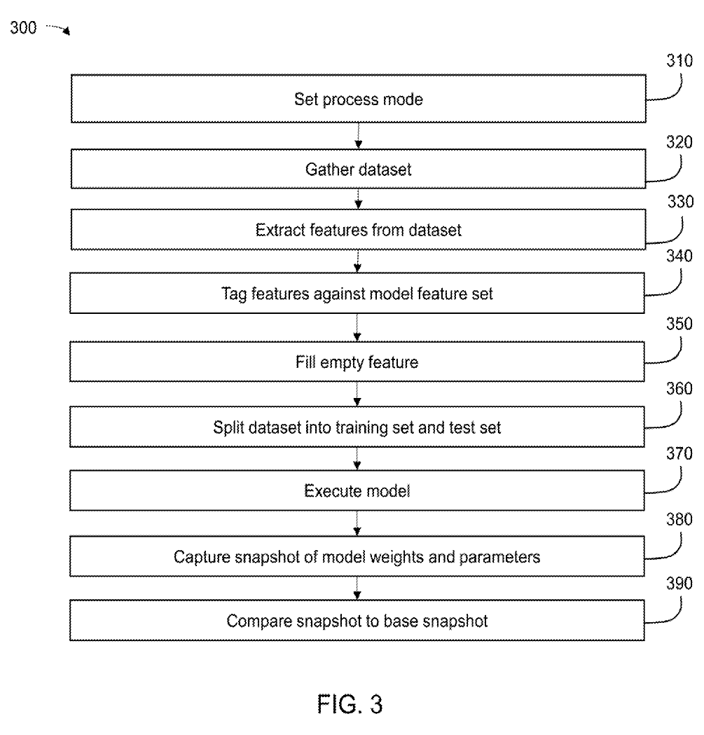

The analysis engine 210 can execute the set of algorithms using as input the labeled features to generate a set of candidate models. The analysis engine 210 can split the labeled features into a training set and a test set, using the training set to train each algorithm of the set of algorithms to generate the candidate models, and using the test set to evaluate the candidate models. The same training set and test set can be used for each candidate model, or different training sets and test sets can be used for different candidate models. Additional details on the execution of the set of algorithms to generate the set of candidate models is provided in FIG. 3.

The analysis engine 210 can compare the set of candidate models to each other to select a best candidate model. In some implementations, there is only one candidate model. The analysis engine 210 can compare the set of candidate models by calculating error rates for the set of candidate models using the test set. The analysis engine 210 compares the error rate of the best candidate model to the error rate of the target model (i.e., the predictive model 110 or the prescriptive model 120) to determine a relative accuracy of the best candidate model and the target model. The error rate of the target model may be a historical error rate or an error rate determined by executing the target model using as input the target set. In some implementations, the analysis engine 210 compares the error rates of all of the candidate models to the error rate of the target model. In an example, the analysis engine 210 generates a ranking based on the error rates of the target model and the candidate models. The analysis engine 210 can store the error rates, the relative accuracy of the best candidate model and the target model, and/or the ranking of error rates in the outcome database 270.

The analysis engine 210 can determine a feature importance for the set of features used as input for the best candidate model and the target model. The analysis engine 210 can determine a feature importance for each feature of the set of features for the best candidate model and can determine a feature importance for each feature of the set of features for the target model. The analysis engine 210 can calculate a drift for each feature of the set of features based on a difference in feature importance for each feature between the best candidate model and the target model. The drift can be equal to the difference in feature importance between the best candidate model and the target model. The drift can indicate how an importance, or a usefulness of a feature has changed from when the target model was trained. In an example, a large drift for the feature of ‘marijuana use’ can indicate that a usefulness of marijuana use as a predictor of recidivism has changed.

The analysis engine 210 can store the feature importance and/or the drift in the outcome database 270. In some implementations, the analysis engine 210 generates a drift vector including a drift value for each feature. The analysis engine 210 can generate an alert based on the overall drift for the features, a drift for one or more individual features, and/or the relative accuracy of the best candidate model and the target model. In an example, the analysis engine 210 generates the alert based on the drift exceeding a predetermined drift threshold, and/or the relative accuracy being below a predetermined accuracy threshold. The alert can indicate that the target model’s accuracy has degraded due to feature drift. The alert can indicate that feature drift has occurred and that the feature drift has contributed to degradation of the target model’s accuracy. The analysis engine 210 can provide data stored in the outcome database 270 for display, including the error rates, the relative accuracy, the drift vector, and/or the alert.

In some implementations, the data interface 220 obtains a dataset including characteristic data for a subject of interest and performance data for the subject of interest. The characteristic data may include attributes, measurements, or observations associated with the subject of interest, and the performance data may include outcome information or results associated with the subject of interest. The data interface 220 can receive the dataset from one or more of the collected data database 130, the third-party database 140, and the recommendation database 150.

In some implementations, the analysis engine 210 executes the target model using the test set to generate target predictions and determines an error rate for the target model by comparing the target predictions to target feature values of the test set. The analysis engine 210 executes at least one of the candidate models using the test set to generate candidate predictions and determines error rates for the candidate models by comparing the candidate predictions to the target feature values of the test set. The analysis engine 210 computes a relative accuracy metric using at least the error rate for the target model and at least one error rate for the candidate models.

In some implementations, the analysis engine 210 determines first feature-importance values for the input features for the target model and determines second feature-importance values for the input features for at least one of the candidate models. The analysis engine 210 determines a drift value for at least one input feature using a difference between a corresponding one of the first feature-importance values and a corresponding one of the second feature-importance values.

In some implementations, upon a determination that the drift value exceeds a drift threshold or the relative accuracy metric falls below an accuracy threshold, the analysis engine 210 generates an alert that includes at least one of the drift value and the relative accuracy metric. The analysis engine 210 stores, in the outcome database 270, at least one of the alert, the error rate for the target model, the error rates for the candidate models, the first feature-importance values, the second feature-importance values, or the drift value.

FIG. 3 is a flow diagram of an example method 300 for detecting or otherwise identifying data drift. The method 300 may include more, fewer, or different operations than shown. One or more operations may be performed in the order shown, in a different order, or concurrently. The method 300 may be performed by the analysis engine 210 of FIG. 2.

At operation 310, a process mode is set. For example, a process mode can be set 310 for the analysis engine 210. The process mode may be set to generate a new model (i.e., the set of candidate models) or set to evaluate the target model. Evaluating the target model can include executing the target model using as input the test set to determine an error rate of the target model. The analysis engine 210 can evaluate the target model and generate a new model to compare the target model to the new model. The process mode can be part of a monitor configuration defining how the analysis engine 210 monitors the target model.

At operation 320, a data set is gathered. For example, The analysis engine 210 can gather a dataset. The dataset corresponds to data used by the target model as input and data corresponding to outputs of the target model. In an example, the dataset for a target model to predict recidivism includes data of characteristics of individuals (input data to the target model) as well as recidivism data for the individuals (ground truth data corresponding to an output of target model). The analysis engine 210 can gather the dataset from the data interface 220.

In another example embodiment, the dataset for a target model to predict equipment wear includes characteristics of a given type of equipment (input data to the target model) as well as wear data or failure data for the equipment (ground truth data corresponding to an output of the target model). In another example embodiment, the dataset for a target model to predict or otherwise analyze crop performance includes characteristics of a given type of crop and/or locale (input to the target model) as well as performance data, such as growth patterns, growth outcomes, quality data, longevity data, yield data, disease data, and other biological outcomes (ground truth data corresponding to an output of the target model). Other examples of data sets that can be gathered can be in domains including, but not limited to healthcare, financial services, insurance, manufacturing, etc.

At operation 330, features are extracted from the data set. For example, the analysis engine 210 can extract 330 features from the dataset, or transforms the dataset into features. The features can be features used by the target model and/or additional features. The features can be included in feature vectors, where each feature vector stores features for an individual.

At operation 340, features are tagged 340 based on a model feature set. For example, the analysis engine 210 can tag the features based on the model feature set. In an example, the analysis engine 210 tags (i.e., labels) the feature vectors to indicate which features are used by the target model. The analysis engine 210 tags a target feature within the feature vectors. In an example, a feature vector includes fifteen features, ten of which are used by the target model, and one of which is recidivism, which is tagged as a target feature, as the target model predicts recidivism based on the other nine features used by the target model.

In some implementations, at operation 350, any empty features in the feature vectors can be filled. For example, the analysis engine 210 can fill 350 any empty features in the feature vector. In an example, if additional features are being evaluated for use in predicting the target feature, the additional features can be added to the feature vectors. In this example, if the additional features are missing (i.e., data for the additional features is missing), the analysis engine 210 estimates the missing features based on the other features and/or the data used to generate the feature vectors. In other embodiments, if the additional features are missing, they may be obtained from an additional data set (e.g., a third-party data set.

At operation 360, the data set (e.g., the feature vectors) can be split into a training set and test set. For example, the analysis engine 210 can split 360 the dataset (e.g., the feature vectors) into a training set and a test set. In an example, the analysis engine 210 splits a population of individuals into a training set including 70% of the population and a test set including 30% of the population, where the feature vectors of the individuals in the training set are used in training and the feature vectors of the individuals in the test set are used in testing.

At operation 370, the target model and/or the set of candidate models is executed. For example, the analysis engine 210 can execute the target model and/or the set of candidate models. If the process mode is set to evaluate the target model, the analysis engine 210 can execute the target model using the test set to determine an error rate of the target model. If the process mode is set to generate a new model, the analysis engine 210 can execute the set of candidate models (e.g., the set of algorithms) using as input the training set to train the set of candidate models and then executes the set of candidate models using as input the test set to determine error rates of the set of candidate models. Executing the target model and/or the set of candidate models may include creating the target model and/or the set of candidate models. In some implementations, the target model and/or the set of candidate models are created by executing new models (i.e., blank, randomized, etc.) using as input the training set. In some implementations, the target model and/or the set of candidate models are untrained (e.g., randomized parameters) until executed using as input the training set.

At operation 380, a snapshot of model weights and parameters can be captured. For example, the analysis engine 210 can capture a snapshot of model weights and parameters. If the process mode is set to evaluate the target model, the analysis engine 210 takes a base snapshot of the weights and parameters of the target model as well as its error rate. The base snapshot corresponds to a performance of the target model in a point in time. If the process mode is set to generate a new model, the analysis engine 210 captures a snapshot of each candidate model or the best candidate model according to the error rates, the snapshot including the model weights and parameters as well as the corresponding error rate.

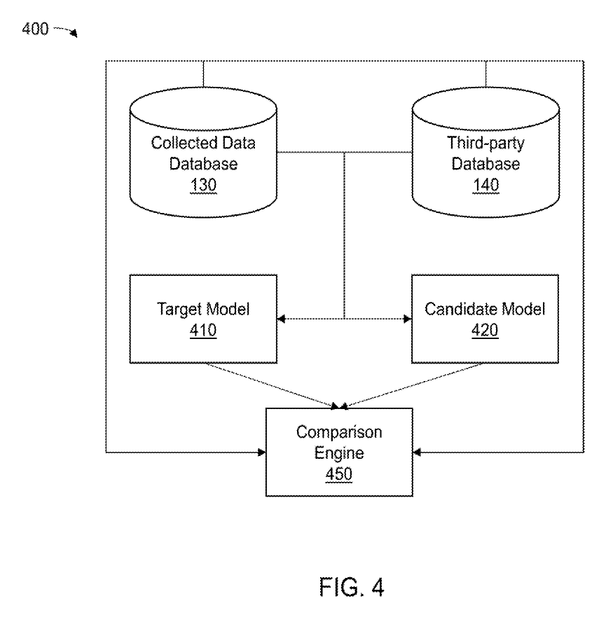

At operation 390, the snapshot of the best candidate model (or the snapshots of the set of candidate models) can be compared to the base snapshot of the target model. For example, the analysis engine 210 compares the snapshot of the best candidate model (or the snapshots of the set of candidate models) to the base snapshot of the target model. The analysis engine 210 can compare the error rates of the set of candidate models to the error rate of the target model as well as feature importance (e.g., weights) of features for the set of candidate models and the target model. In this way, the analysis engine 210 can determine accuracy degradation of the target model, feature drift of the various features, and how the feature drift is connected to the accuracy degradation of the target model. A system for comparing the target model to the best candidate model is illustrated in FIG. 4.

FIG. 4 is an illustration of an example system 400 for comparing a target model 410 with a candidate model 420. The system includes the target model 410, the candidate model 420, the collected data database 130 of FIG. 1, the third-party database 140 of FIG. 1, a comparison engine 450, and a comparison database 460. The system 400 may be used in executing the target model 410 and the candidate model 420 to compare the target model 410 to the candidate model 420, as in the method 300.

The target model 410 and the candidate model 420 are executed using as input data from the collected data database 130 and the third-party database 140. In some implementations, the candidate model 420 is already trained, and the input data is a test set, as described herein. The comparison engine 450 compares the output of the target model 410 and the output of the candidate model 420 to ground-truth target feature data from the collected data database 130 and the third-party database 140 to generate error rates for the target model 410 and the candidate model 420. In an example, the comparison engine 450 generates error rates for each of the target features and the error rate for each of the target model 410 and the candidate model 420 is a composite error rate. In an example, the target feature is recidivism, and the recidivism predictions of the target model 410 and the candidate model 420 are compared to actual recidivism data to determine error rates of the target model 410 and the candidate model 420. In some implementations, the comparison engine 450 can be part of the analysis engine 210 of FIG. 2.

The comparison engine 450 (and/or the analysis engine 210) can be used to evaluate target models, candidate models, and new features. In an example, a new feature present in data can be evaluated by including the new feature as an input feature for candidate models and determining how use of the new feature improves an accuracy of the candidate models as well as a feature importance of the new feature. In this example, the accuracy of the candidate models using the feature and the feature importance of the new feature can indicate a usefulness of the new feature in predicting the target feature or features.

In some implementations, the candidate model 420 can be used to replace the target model 410 based on the candidate model 420 having a lower error rate (higher accuracy) than the target model 410. In some implementations, the candidate model 420 can be used as a starting point for generating a new model based on adding new features as input to the candidate model or by generating new candidate models using a new set of features.

In some implementations, the system 400 can be used to generate a new model, without comparing the new model to the target model 410. In these implementations, the candidate model 420 can be created or trained by executing the candidate model 420 using a training set, as discussed herein. The candidate model 420 is executed using as input data from the collected data database 130 and the third-party database 140, such as a test set. The comparison engine 450 compares the output of the candidate model 420 to ground-truth target feature data from the collected data database 130 and the third-party database 140 to generate an error rate for the candidate model 420. The candidate model 420 can be iteratively trained and evaluated to improve the candidate model 420. The comparison engine 450 can compare the error rates of the candidate model 420 across iterations to determine how the candidate model 420 is improving within the training iterations. In an example, the comparison engine 450 triggers an end of the training based on the error rates falling below a predetermined threshold or a rate of change of the error rate falling between a predetermined threshold (i.e., error rate stabilizes).

In some implementations, the candidate model 420 is generated or trained with one or more new target features that are not target features of the target model 410. The candidate model 420 can be trained with a set of target features that include the target features of the target model 410 as well as the new target features. In this way, the candidate model 420 can be trained to predict different and/or additional features. The candidate model 420 can be iteratively trained to increase an accuracy of the candidate model 420 in predicting the set of target features. The comparison engine 450 can compare the output of the candidate model 420 to the ground-truth target feature data from the collected data database 130 and the third-party database 140 to generate an error rate for the candidate model 420 for each target feature of the set of target features. In an example, the error rate for the candidate model 420 for the new target features is high in early training iterations, but is lower in later training iterations as the candidate model 420 is trained to predict the new target features.

In some implementations, the system 400 receives, via a data interface, a dataset including characteristic data for a subject of interest and performance data for the subject of interest. The characteristic data may include attributes, measurements, or observations associated with the subject of interest, and the performance data may include outcome information or results associated with the subject of interest. The data interface can receive the dataset from one or more of the collected data database 130 and the third-party database 140.

In some implementations, the system 400 generates feature vectors from the dataset, each feature vector corresponding to input features for the target model 410. The comparison engine 450 executes the target model 410 using a test set to generate target predictions and determines an error rate for the target model 410 by comparing the target predictions to target feature values of the test set. The comparison engine 450 executes at least one of the candidate models 420 using the test set to generate candidate predictions and determines error rates for the candidate models 420 by comparing the candidate predictions to the target feature values of the test set.

In some implementations, the comparison engine 450 computes a relative accuracy metric using at least the error rate for the target model 410 and at least one error rate for the candidate models 420. The comparison engine 450 determines first feature-importance values for the input features for the target model 410 and determines second feature-importance values for the input features for at least one of the candidate models 420. The comparison engine 450 determines a drift value for at least one input feature using a difference between a corresponding one of the first feature-importance values and a corresponding one of the second feature-importance values.

In some implementations, upon a determination that at least one of the drift value exceeds a drift threshold and the relative accuracy metric falls below an accuracy threshold, the comparison engine 450 generates an alert that includes at least one of the drift value and the relative accuracy metric. The comparison engine 450 stores, in the comparison database 460, at least one of the alert, the error rate for the target model 410, the error rates for the candidate models 420, the first feature-importance values, the second feature-importance values, or the drift value.

In an example, an assessment uses four models to evaluate different aspects of recidivism to determine a likelihood of recidivism. Each model applies weights to a set of features to generate a risk score, where an overall risk score is generated based on the four risk scores generated by the four models. In this example, one of the models is an Alcohol/Drug use model that uses features such as past alcohol use, past marijuana use, past cocaine use, and past methamphetamine use to determine a recidivism risk score for an individual. The weights applied to each feature are generated during creation of the model, or during training of the model. The model is trained using data of individuals representing a historic correlation between the features and the recidivism risk score, corresponding to the point in time when the training data was collected. However, as time passes, connections between features and recidivism change, as well as populations of incarcerated individuals. In this example, legalization of marijuana and corresponding prohibitions against using marijuana use in evaluating recidivism render the Alcohol/Drug use model less accurate, as its weights correspond to circumstances very different from current circumstances. The legalization of marijuana changes policing strategies, arrests, prison populations, and other factors. In this example, 12% of a prison population was incarcerated for possession and/or use of marijuana, meaning that the legalization of marijuana radically shifts the prison population and the input data for the Alcohol/Drug use model. To evaluate the Alcohol/Drug use model, the analysis engine 210 gathers a current dataset including prisoner alcohol and drug use as well as recidivism data, extracts feature vectors from the dataset, tags recidivism as a target feature for prediction, and splits the feature vectors into two groups: a training set and a test set. The analysis engine 210 executes the Alcohol/Drug use model using as input the test set to determine an error rate for the Alcohol/Drug use model. The analysis engine 210 generates a set of candidate models by executing a set of algorithms using as input the training set and then executes the set of candidate models using as input the test set to determine error rates for the set of candidate models. The analysis engine 210 determines the error rates for the Alcohol/Drug use model and the set of candidate models by comparing their recidivism predictions to the recidivism feature in the feature vectors in the test set. The analysis engine 210 selects a best candidate model based on the error rates of the set of candidate models. The analysis engine 210 compares the error rate of the best candidate model to the error rate of the Alcohol/Drug use model to determine a relative accuracy of the Alcohol/Drug use model to the best candidate model. The analysis engine 210 determines a feature importance vector for the Alcohol/Drug use model and the best candidate model indicating feature importance for the features used by the Alcohol/Drug use model. The analysis engine 210 calculates a drift vector based on a difference between the feature importance vectors for the Alcohol/Drug use model and the best candidate model. The analysis engine 210 generates an alert for display based on the drift vector and the relative accuracy of the Alcohol/Drug use model and the best candidate model to show how the accuracy of the Alcohol/Drug use model degraded and how the data of the features of the Alcohol/Drug use model have shifted. The analysis engine 210 then repeats the process, but using new features extracted from the current dataset that do not include past marijuana use to train the set of candidate models. Once a new best candidate model is selected form the set of candidate models trained using the new features, the analysis engine 210 determines a relative accuracy and a drift vector using the new best candidate model and the Alcohol/Drug use model to show how use of the new feature improves prediction accuracy.

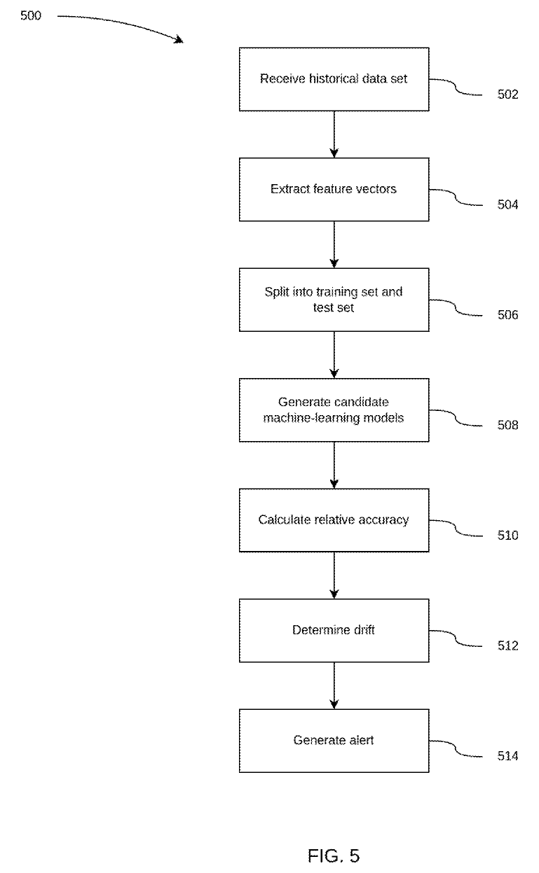

FIG. 5 is a flow diagram of an example method for identifying model drift. The method 500 may include more, fewer, or different operations than shown. One or more operations may be performed in the order shown, in a different order, and/or concurrently. The method 500 may be performed by one or more components of the system 100 of FIG. 1, the system 200 of FIG. 2, and/or the system 400 of FIG. 4.

The method 500 can be applied across various domains where predictive models are used to forecast outcomes based on historical data. In the domain of public safety, the method 500 can be applied to assess incarcerated individuals by detecting drift in behavioral predictive models that predict recidivism risk, institutional violence, or rehabilitation outcomes based on features such as criminal history, demographic information, and program participation. In industrial settings, the method 500 can be applied to analyze equipment wear by detecting drift in predictive maintenance models that predict equipment failure based on sensor readings, vibration patterns, temperature measurements, and operational parameters. In agricultural applications, the method 500 can be applied to analyze crop performance by detecting drift in yield prediction models that predict harvest outcomes based on soil composition, weather patterns, irrigation data, and fertilizer application rates. In chemical manufacturing, the method 500 can be applied to analyze chemical reactions by detecting drift in process optimization models that predict reaction yields or product quality based on reactant concentrations, temperature profiles, pressure conditions, and catalyst properties. In financial services, the method 500 can be applied to detect drift in credit risk models that predict loan default based on borrower characteristics, payment history, and economic indicators. In healthcare, the method 500 can be applied to detect drift in diagnostic models that predict disease progression based on patient symptoms, laboratory results, and treatment histories.

At operation 502, a historical data set is received including characteristics of a subject of interest and performance data for the subject of interest. The historical data set corresponds to data used by a predictive model as input and data corresponding to outputs of the predictive model. In an example, the historical data set for a predictive model configured to predict equipment failure includes sensor readings, operational parameters, and maintenance records for industrial machinery (input data to the predictive model) as well as actual failure events for the machinery (ground truth data corresponding to an output of the predictive model). In another example, the historical data set for a predictive model configured to predict insurance claim outcomes includes policyholder characteristics, claim details, and historical claim patterns as well as actual claim resolution data. In another example, the historical data set for a predictive model configured to predict weather conditions includes atmospheric measurements, satellite imagery data, and historical weather patterns as well as actual observed weather outcomes.

At operation 504, feature vectors are extracted from the historical data set corresponding to the input features for the predictive model. The features can be features used by the predictive model and/or additional features. The features are included in feature vectors, where each feature vector stores features for an individual instance or observation. In an example, feature vectors are extracted from financial transaction data, where each feature vector stores features for a transaction including transaction amount, merchant category, time of day, and geographic location.

In some implementations, the feature vectors include the input features of the predictive model and at least one additional feature. The additional features can be features that are present in the historical data set but are not currently used by the predictive model. In an example, a predictive model for predicting loan default uses features including credit score, income level, and debt-to-income ratio, and the feature vectors include these input features as well as additional features such as employment tenure and geographic region that are not currently used by the predictive model but are available in the historical data set.

In some implementations, a feature included in the feature vectors is labeled as a target feature. The target feature corresponds to the output that the predictive model is configured to predict. In an example, for a predictive model configured to predict customer churn, a churn indicator feature in the feature vectors is labeled as the target feature.

In some implementations, machine-learning algorithms are selected based on the target feature. The selection of algorithms can be based on characteristics of the target feature, such as whether the target feature is categorical or continuous. In an example, classification algorithms are selected when the target feature is a binary classification feature, and regression algorithms are selected when the target feature is a continuous numerical feature.

In some implementations, selecting the machine-learning algorithms based on the target feature includes applying a mapping of features to algorithms to the target feature to select the machine-learning algorithms. The mapping associates types of target features with appropriate algorithm types. In an example, a mapping associates binary target features with classification algorithms including logistic regression, random forest classifiers, and support vector machines, and associates continuous target features with regression algorithms including linear regression, gradient boosted regressors, and neural network regressors.

At operation 506, the feature vectors are split into a training set and a test set. The training set is used to train candidate machine-learning models, and the test set is used to evaluate the predictive model and the candidate machine-learning models. In an example, a population of 50,000 feature vectors is split into a training set including 35,000 feature vectors and a test set including 15,000 feature vectors.

At operation 508, candidate machine-learning models are generated by executing machine-learning algorithms using the training set as input. The candidate machine-learning models are trained using the training set to learn relationships between the input features and the target feature. In an example, three candidate machine-learning models are generated by executing a random forest algorithm, a gradient boosted decision tree algorithm, and a neural network algorithm using the training set as input.

In some implementations, the candidate machine-learning models include one or more of a support vector machine, a decision tree, ensemble trees, a generalized additive model, a neural network, a naïve Bayes model, a k-nearest neighbor, a discriminant analysis model, linear regression model, a non-linear regression model, a generalized linear model, or a gaussian process regression. The selection of candidate machine-learning models can be based on the characteristics of the target feature and the input features. In an example, for a binary classification target feature, the candidate machine-learning models include a support vector machine, a random forest (ensemble trees), and a logistic regression model (generalized linear model).

At operation 510, a relative accuracy of the predictive model and the candidate machine-learning models is calculated using an error rate for the predictive model and error rates of the candidate machine-learning models. The relative accuracy indicates how the accuracy of the predictive model compares to the accuracy of the candidate machine-learning models trained on current data. In an example, the predictive model has an error rate of 18% and the best candidate machine-learning model has an error rate of 11%, indicating that the predictive model exhibits a relative accuracy degradation of approximately 39% compared to the best candidate machine-learning model.

In some implementations, the error rate for the predictive model is calculated by executing the predictive model using as input the test set, and the error rates for the candidate machine-learning models are calculated by executing the candidate machine-learning models using as input the test set. The predictions generated by the predictive model and the candidate machine-learning models are compared to the ground-truth target feature values in the test set to determine the error rates. In an example, the predictive model generates predictions for 15,000 instances in the test set, and the predictions are compared to the actual target feature values to calculate an error rate representing the proportion of incorrect predictions.

In some implementations, a feature importance of the input features for the predictive model is determined, and a feature importance of the input features for the candidate machine-learning models is determined. The feature importance indicates how much each input feature contributes to the predictions generated by the respective model. In an example, the feature importance for the predictive model indicates that a first feature has an importance of 0.30, a second feature has an importance of 0.25, and a third feature has an importance of 0.20, while the feature importance for the best candidate machine-learning model indicates that the first feature has an importance of 0.15, the second feature has an importance of 0.35, and the third feature has an importance of 0.28.

At operation 512, a drift is determined based on a difference between a feature importance of the input features for the predictive model and a feature importance of the input features for the candidate machine-learning models. The drift indicates how the importance or usefulness of each feature has changed from when the predictive model was trained. In an example, a drift for a particular feature is calculated as the difference between the feature importance of 0.30 for the predictive model and the feature importance of 0.15 for the best candidate machine-learning model, resulting in a drift of -0.15 indicating decreased importance.

In some implementations, the drift comprises a drift vector including a drift value for each feature in the feature vectors. The drift vector provides a comprehensive view of how feature importance has shifted across all input features. In an example, the drift vector includes drift values of -0.15, +0.10, +0.08, -0.05, and +0.02 for five input features, indicating that the first feature has decreased in importance while the second and third features have increased in importance.

At operation 514, in response to the drift exceeding a predetermined drift threshold and/or the relative accuracy being below a predetermined accuracy threshold, an alert is generated including the drift and the relative accuracy. The alert indicates that the predictive model's accuracy has degraded due to data drift and provides information about which features have shifted in importance. In an example, an alert is generated when the drift for two features exceeds a predetermined drift threshold of 0.10 and the relative accuracy degradation exceeds a predetermined accuracy threshold of 20%, the alert including the drift vector and the relative accuracy to explain the accuracy degradation.

In some implementations, the alert includes an indication of the feature importance of the at least one additional feature. The feature importance of the additional feature indicates whether the additional feature would be useful in improving prediction accuracy if incorporated into the predictive model. In an example, the alert indicates that an additional feature not currently used by the predictive model has a feature importance of 0.22 in the best candidate machine-learning model, suggesting that incorporating this additional feature could improve prediction accuracy.

In some implementations, the historical data set is obtained via a data interface that receives data from one or more data sources. The historical data set includes characteristic data for a subject of interest and performance data for the subject of interest. The subject of interest may be an individual, an entity, a piece of equipment, a process, or any other item for which predictions are generated. The characteristic data may include attributes, measurements, or observations associated with the subject of interest, and the performance data may include outcome information or results associated with the subject of interest.

In some implementations, the predictive model is a target machine-learning model. The method 500 includes executing the target machine-learning model using the test set to generate target predictions and determining an error rate for the target machine-learning model by comparing the target predictions to target feature values of the test set. The method 500 includes executing at least one of the candidate machine-learning models using the test set to generate candidate predictions and determining error rates for the candidate machine-learning models by comparing the candidate predictions to the target feature values of the test set.

In some implementations, the method 500 includes computing a relative accuracy metric using at least the error rate for the target machine-learning model and at least one error rate for the candidate machine-learning models. The method 500 includes determining first feature-importance values for the input features for the target machine-learning model and determining second feature-importance values for the input features for at least one of the candidate machine-learning models. The method 500 includes determining a drift value for at least one input feature using a difference between a corresponding one of the first feature-importance values and a corresponding one of the second feature-importance values.

In some implementations, upon a determination that at least one of the drift value exceeds a drift threshold and the relative accuracy metric falls below an accuracy threshold, the method 500 includes generating an alert that includes at least one of the drift value and the relative accuracy metric. The method 500 includes storing, in an outcome data store, at least one of the alert, the error rate for the target machine-learning model, the error rates for the candidate machine-learning models, the first feature-importance values, the second feature-importance values, or the drift value.

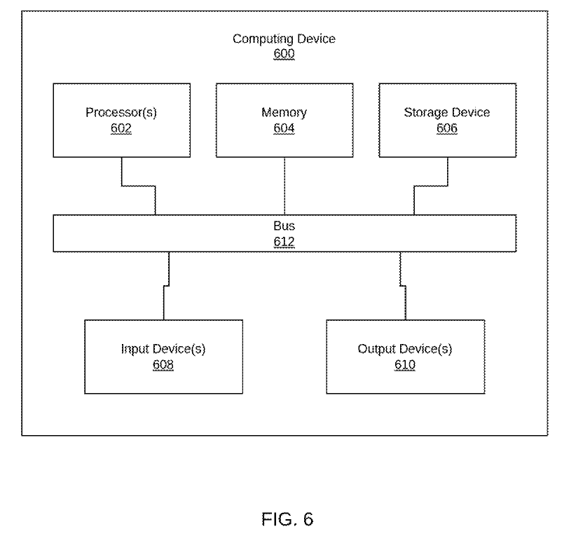

FIG. 6 is an illustration of an example computing device 600. The computing device 600 includes one or more processors 602, memory 604, a storage device 606, one or more input devices 608, one or more output devices 610, and a bus 612. The bus 612 facilitates communication between the processors 602, memory 604, storage device 606, input devices 608, and output devices 610. The processors 602 are configured to execute instructions stored in the memory 604 or the storage device 606 to perform the operations described herein, including the operations of the method 300 of FIG. 3, the method 500 of FIG. 5, the analysis engine 210 of FIG. 2, and the comparison engine 450 of FIG. 4. The memory 604 can store computer program instructions and data for execution by the processors 602, including instructions for receiving historical data sets, extracting feature vectors, splitting feature vectors into training and test sets, generating candidate machine-learning models, calculating relative accuracy, determining drift based on feature importance differences, and generating alerts. The storage device 606 can store datasets, feature vectors, trained machine-learning models, model weights and parameters, snapshots, error rates, drift vectors, and other data used in detecting data drift. The input devices 608 can receive data from external sources, including data from the collected data database 130, the third-party database 140, and other data sources. The output devices 610 can provide alerts, drift vectors, relative accuracy information, and other outputs for display or transmission to other systems. The computing device 600 can implement the system 100 of FIG. 1, the system 200 of FIG. 2, and the system 400 of FIG. 4, and can execute the methods and operations described herein for automatically detecting data drift in predictive models.

In some implementations, the computing device 600 can be a server, a workstation, a desktop computer, a laptop computer, a tablet computer, or a cloud computing instance. The computing device 600 can be a single physical device or can be distributed across multiple physical devices that communicate over a network. The processors 602 can include one or more central processing units (CPUs), graphics processing units (GPUs), tensor processing units (TPUs), or other processors (XPUs) configured to execute machine-learning algorithms and perform numerical computations. The memory 604 can include random access memory (RAM), cache memory, or other volatile memory configured to store data and instructions for rapid access by the processors 602. The storage device 606 can include one or more hard disk drives, solid-state drives, network-attached storage devices, or cloud storage systems configured to persistently store data and instructions. The input devices 608 can include network interfaces, data ports, application programming interfaces (APIs), or other components configured to receive data from external systems and databases. The output devices 610 can include network interfaces, display adapters, notification systems, or other components configured to transmit alerts, reports, and other outputs to users or external systems.

In some implementations, the computing device 600 includes a data interface configured to obtain a dataset including characteristic data for a subject of interest and performance data for the subject of interest. The characteristic data may include attributes, measurements, or observations associated with the subject of interest, and the performance data may include outcome information or results associated with the subject of interest. The data interface can receive the dataset from one or more external data sources, including the collected data database 130 and the third-party database 140.

In some implementations, the processors 602 execute instructions stored in the memory 604 to generate feature vectors from the dataset, each feature vector corresponding to input features for a target machine-learning model. The processors 602 execute the target machine-learning model using a test set to generate target predictions and determine an error rate for the target machine-learning model by comparing the target predictions to target feature values of the test set. The processors 602 execute at least one of the candidate machine-learning models using the test set to generate candidate predictions and determine error rates for the candidate machine-learning models by comparing the candidate predictions to the target feature values of the test set.

In some implementations, the processors 602 compute a relative accuracy metric using at least the error rate for the target machine-learning model and at least one error rate for the candidate machine-learning models. The processors 602 determine first feature-importance values for the input features for the target machine-learning model and determine second feature-importance values for the input features for at least one of the candidate machine-learning models. The processors 602 determine a drift value for at least one input feature using a difference between a corresponding one of the first feature-importance values and a corresponding one of the second feature-importance values.

In some implementations, upon a determination that at least one of the drift value exceeds a drift threshold and the relative accuracy metric falls below an accuracy threshold, the processors 602 generate an alert that includes at least one of the drift value and the relative accuracy metric. The processors 602 store, in the storage device 606 or an outcome data store, at least one of the alert, the error rate for the target machine-learning model, the error rates for the candidate machine-learning models, the first feature-importance values, the second feature-importance values, or the drift value.

In an example implementation, a correctional facility operates a behavioral predictive model trained to predict institutional violence risk for incarcerated individuals. The behavioral predictive model uses input features including age at first arrest, number of prior violent offenses, gang affiliation status, disciplinary infractions during current incarceration, mental health diagnosis indicators, and participation in rehabilitation programs. The behavioral predictive model was trained using data collected over a five-year period ending three years prior to the current evaluation.

The analysis engine receives a historical data set from the collected data database and the third-party database, the historical data set including characteristics of 15,000 incarcerated individuals and institutional violence outcome data spanning the most recent eighteen-month period. The analysis engine extracts feature vectors from the historical data set, where each feature vector corresponds to an individual and includes values for each of the input features used by the behavioral predictive model as well as the institutional violence outcome (whether the individual committed an act of institutional violence during the observation period).

The analysis engine labels the institutional violence outcome as the target feature for prediction. The analysis engine applies a mapping of features to algorithms, determining that the target feature is a binary classification feature, and selects classification algorithms including a random forest classifier, a gradient boosted decision tree, and a logistic regression model.

The analysis engine splits the 15,000 feature vectors into a training set of 10,500 feature vectors and a test set of 4,500 feature vectors. The analysis engine generates three candidate machine-learning models by executing the selected classification algorithms using the training set as input. The random forest classifier trains using 500 decision trees with a maximum depth of 20 nodes. The gradient boosted decision tree trains using 200 boosting iterations with a learning rate of 0.1. The logistic regression model trains using L2 regularization with a regularization parameter of 0.01.

The analysis engine executes the behavioral predictive model using the test set as input, generating institutional violence predictions for each of the 4,500 individuals in the test set. The analysis engine compares these predictions to the actual institutional violence outcomes in the test set and calculates an error rate of 23% for the behavioral predictive model. The analysis engine executes each of the three candidate machine-learning models using the test set as input and calculates error rates of 14% for the random forest classifier, 15% for the gradient boosted decision tree, and 18% for the logistic regression model.

The analysis engine selects the random forest classifier as the best candidate model based on its lowest error rate. The analysis engine calculates a relative accuracy by comparing the 14% error rate of the best candidate model to the 23% error rate of the behavioral predictive model, determining that the behavioral predictive model exhibits a 39% relative accuracy degradation compared to the best candidate model.

The analysis engine determines feature importance values for the behavioral predictive model, finding that gang affiliation status has a feature importance of 0.35, number of prior violent offenses has a feature importance of 0.25, disciplinary infractions has a feature importance of 0.20, age at first arrest has a feature importance of 0.10, mental health diagnosis indicators has a feature importance of 0.07, and participation in rehabilitation programs has a feature importance of 0.03. The analysis engine determines feature importance values for the best candidate model, finding that disciplinary infractions has a feature importance of 0.32, mental health diagnosis indicators has a feature importance of 0.28, gang affiliation status has a feature importance of 0.18, participation in rehabilitation programs has a feature importance of 0.12, number of prior violent offenses has a feature importance of 0.07, and age at first arrest has a feature importance of 0.03.

The analysis engine calculates a drift vector based on the difference between the feature importance values for the behavioral predictive model and the best candidate model. The drift vector indicates that gang affiliation status drifted by -0.17 (decreased importance), number of prior violent offenses drifted by -0.18 (decreased importance), disciplinary infractions drifted by +0.12 (increased importance), mental health diagnosis indicators drifted by +0.21 (increased importance), age at first arrest drifted by -0.07 (decreased importance), and participation in rehabilitation programs drifted by +0.09 (increased importance).

The analysis engine determines that the drift exceeds a predetermined drift threshold of 0.15 for three features (gang affiliation status, number of prior violent offenses, and mental health diagnosis indicators) and that the relative accuracy degradation of 39% exceeds a predetermined accuracy threshold of 15%. The analysis engine generates an alert including the drift vector and the relative accuracy, indicating that the behavioral predictive model has experienced significant accuracy degradation due to data drift.

The alert explains that the data drift correlates with changes in the incarcerated population over the three-year period since the behavioral predictive model was trained. During this period, the correctional facility implemented enhanced mental health screening and treatment programs, resulting in mental health diagnosis indicators becoming a stronger predictor of institutional violence outcomes. Additionally, gang intervention programs reduced the correlation between gang affiliation status and institutional violence. The alert identifies that the behavioral predictive model's reliance on gang affiliation status and number of prior violent offenses, which were strong predictors in the original training data, now contributes to prediction errors because these features have diminished predictive value in the current population.

This implementation provides technical advantages by automatically detecting when the behavioral predictive model's accuracy has degraded without requiring manual review of prediction outcomes. The drift vector provides explainability by identifying which specific features have shifted in importance, enabling correctional administrators to understand why the model's accuracy has degraded rather than simply observing that predictions are less accurate. The comparison between the behavioral predictive model and the best candidate model quantifies the accuracy improvement achievable by retraining, allowing administrators to make informed decisions about whether to deploy an updated model. The automated alert generation ensures that accuracy degradation is detected promptly, preventing continued reliance on an outdated model that produces inaccurate institutional violence predictions.

In another example implementation, a manufacturing facility operates a predictive model trained to predict equipment failure for industrial machinery based on sensor readings and operational parameters. The predictive model uses input features including vibration amplitude measurements, operating temperature readings, motor current draw, bearing acoustic emissions, lubricant contamination levels, and cumulative operating hours. The predictive model was trained using data collected from 200 machines over a four-year period ending two years prior to the current evaluation.

The analysis engine receives a historical data set from sensor databases and maintenance record systems, the historical data set including characteristics of 180 machines and equipment failure outcome data spanning the most recent twelve-month period. The analysis engine extracts feature vectors from the historical data set, where each feature vector corresponds to a machine observation period and includes values for each of the input features used by the predictive model as well as the equipment failure outcome (whether the machine experienced a failure requiring unscheduled maintenance during the observation period).

The analysis engine labels the equipment failure outcome as the target feature for prediction. The analysis engine applies a mapping of features to algorithms, determining that the target feature is a binary classification feature, and selects classification algorithms including a random forest classifier, a support vector machine, and a gradient boosted decision tree.

The analysis engine splits the 45,000 feature vectors into a training set of 31,500 feature vectors and a test set of 13,500 feature vectors. The analysis engine generates three candidate machine-learning models by executing the selected classification algorithms using the training set as input. The random forest classifier trains using 400 decision trees with a maximum depth of 15 nodes. The support vector machine trains using a radial basis function kernel with a regularization parameter of 1.0. The gradient boosted decision tree trains using 150 boosting iterations with a learning rate of 0.05.

The analysis engine executes the predictive model using the test set as input, generating equipment failure predictions for each of the 13,500 observation periods in the test set. The analysis engine compares these predictions to the actual equipment failure outcomes in the test set and calculates an error rate of 19% for the predictive model. The analysis engine executes each of the three candidate machine-learning models using the test set as input and calculates error rates of 9% for the random forest classifier, 11% for the support vector machine, and 10% for the gradient boosted decision tree.

The analysis engine selects the random forest classifier as the best candidate model based on its lowest error rate. The analysis engine calculates a relative accuracy by comparing the 9% error rate of the best candidate model to the 19% error rate of the predictive model, determining that the predictive model exhibits a 53% relative accuracy degradation compared to the best candidate model.

The analysis engine determines feature importance values for the predictive model, finding that vibration amplitude measurements has a feature importance of 0.38, cumulative operating hours has a feature importance of 0.22, motor current draw has a feature importance of 0.18, operating temperature readings has a feature importance of 0.12, bearing acoustic emissions has a feature importance of 0.07, and lubricant contamination levels has a feature importance of 0.03. The analysis engine determines feature importance values for the best candidate model, finding that bearing acoustic emissions has a feature importance of 0.31, lubricant contamination levels has a feature importance of 0.24, vibration amplitude measurements has a feature importance of 0.19, operating temperature readings has a feature importance of 0.14, motor current draw has a feature importance of 0.08, and cumulative operating hours has a feature importance of 0.04.

The analysis engine calculates a drift vector based on the difference between the feature importance values for the predictive model and the best candidate model. The drift vector indicates that vibration amplitude measurements drifted by -0.19 (decreased importance), cumulative operating hours drifted by -0.18 (decreased importance), motor current draw drifted by -0.10 (decreased importance), operating temperature readings drifted by +0.02 (slightly increased importance), bearing acoustic emissions drifted by +0.24 (increased importance), and lubricant contamination levels drifted by +0.21 (increased importance).

The analysis engine determines that the drift exceeds a predetermined drift threshold of 0.15 for four features (vibration amplitude measurements, cumulative operating hours, bearing acoustic emissions, and lubricant contamination levels) and that the relative accuracy degradation of 53% exceeds a predetermined accuracy threshold of 20%. The analysis engine generates an alert including the drift vector and the relative accuracy, indicating that the predictive model has experienced significant accuracy degradation due to data drift.

The alert explains that the data drift correlates with changes in the manufacturing facility's equipment and maintenance practices over the two-year period since the predictive model was trained. During this period, the facility upgraded vibration dampening systems on machinery, reducing the correlation between vibration amplitude and equipment failure. Additionally, the facility implemented condition-based maintenance protocols that replaced components based on acoustic emission patterns and lubricant analysis rather than cumulative operating hours, fundamentally changing the relationship between these features and failure outcomes. The alert identifies that the predictive model's reliance on vibration amplitude measurements and cumulative operating hours, which were strong predictors in the original training data, now contributes to prediction errors because these features have diminished predictive value given the current equipment configuration and maintenance practices.

This implementation provides technical advantages by automatically detecting when the predictive model's accuracy has degraded without requiring manual analysis of maintenance records and failure events. A technical problem of data drift, which is introduced by the use of machine learning models, is addressed with this technical solution. The drift vector provides explainability by identifying which specific sensor measurements and operational parameters have shifted in importance, enabling maintenance engineers to understand why the model's accuracy has degraded rather than simply observing increased false positive or false negative rates. The comparison between the predictive model and the best candidate model quantifies the accuracy improvement achievable by retraining, allowing facility managers to make informed decisions about whether to deploy an updated model. The automated alert generation ensures that accuracy degradation is detected promptly, preventing continued reliance on an outdated model that produces inaccurate equipment failure predictions, which reduces unplanned downtime and optimizes maintenance resource allocation.

In an example implementation, a computer-implemented method for automatically detecting data drift in a predictive model that predicts outcomes based on input features, comprises: receiving, by one or more processors, a historical data set including characteristics of a subject of interest and performance data for the subject of interest; extracting, by the one or more processors, feature vectors from the historical data set corresponding to the input features for the predictive model; splitting, by the one or more processors, the feature vectors into a training set and a test set; generating, by the one or more processors, candidate machine-learning models by executing machine-learning algorithms using as input the training set; calculating, by the one or more processors, a relative accuracy of the predictive model and the candidate machine-learning models using an error rate for the predictive model and error rates of the candidate machine-learning models; determining, by the one or more processors, a drift based on a difference between a feature importance of the input features for the predictive model and a feature importance of the input features for the candidate machine-learning models; and in response to the drift exceeding a predetermined drift threshold and/or the relative accuracy being below a predetermined accuracy threshold, generating, by the one or more processors, an alert including the drift and the relative accuracy.

In another example implementation, a system comprises: one or more processors; and memory storing instructions that, when executed by the one or more processors, cause the one or more processors to: receive a historical data set including characteristics of a subject of interest and performance data for the subject of interest; extract feature vectors from the historical data set corresponding to the input features for the predictive model; split the feature vectors into a training set and a test set; generate candidate machine-learning models by executing machine-learning algorithms using as input the training set; calculate a relative accuracy of the predictive model and the candidate machine-learning models using an error rate for the predictive model and error rates of the candidate machine-learning models; determine a drift based on a difference between a feature importance of the input features for the predictive model and a feature importance of the input features for the candidate machine-learning models; and in response to at least one of the drift exceeding a predetermined drift threshold and the relative accuracy being below a predetermined accuracy threshold, generate an alert including at least one of the drift and the relative accuracy.

In an example implementation, a system that predicts outcomes based on input features comprises: one or more processors; and memory storing instructions that, when executed by the one or more processors, cause the one or more processors to: obtain, via a data interface, a dataset including characteristic data for a subject of interest and performance data for the subject of interest; generate feature vectors from the dataset, each feature vector corresponding to the input features (and potentially a value for a target feature derived from the outcome data); partition the feature vectors into a training set and a test set; generate candidate machine-learning models; execute a target machine-learning model using the test set to generate target predictions and determine an error rate for the target machine-learning model by comparing the target predictions to target feature values of the test set; execute at least one of the candidate machine-learning models using the test set to generate candidate predictions and determine error rates for the candidate machine-learning models by comparing the candidate predictions to the target feature values of the test set; compute a relative accuracy metric using at least the error rate for the target machine-learning model and at least one error rate for the candidate machine-learning models; determine first feature-importance values for the input features for the target machine-learning model and determine second feature-importance values for the input features for at least one of the candidate machine-learning models; determine a drift value for at least one input feature using a difference between a corresponding one of the first feature-importance values and a corresponding one of the second feature-importance values; upon a determination that the drift value exceeds a drift threshold or the relative accuracy metric falls below an accuracy threshold, generate an alert that includes the drift value and the relative accuracy metric; and store, in an outcome data store, at least one of the alert, the error rate for the target machine-learning model, the error rates for the candidate machine-learning models, the first feature-importance values, the second feature-importance values, or the drift value.

The foregoing detailed description includes illustrative examples of various aspects and implementations and provides an overview or framework for understanding the nature and character of the claimed aspects and implementations. The drawings provide illustration and a further understanding of the various aspects and implementations and are incorporated in and constitute a part of this specification.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “computing device” or “component” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the monitoring device 102) to perform actions by operating on input data and generating an output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks. The processor and the memory can be supplemented by, or incorporated in, special purpose logic circuitry.

While operations are depicted in the drawings in a particular order, such operations are not required to be performed in the particular order shown or in sequential order, and all illustrated operations are not required to be performed. Actions described herein can be performed in a different order. The separation of various system components does not require separation in all implementations, and the described program components can be included in a single hardware or software product.

The phraseology and terminology used herein is for the purpose of description and should not be regarded as limiting. Any references to implementations or elements or acts of the systems and methods herein referred to in the singular may also embrace implementations including a plurality of these elements, and any references in plural to any implementation or element or act herein may also embrace implementations including only a single element. Any implementation disclosed herein may be combined with any other implementation or embodiment.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method for automatically detecting data drift in a behavioral predictive model that predicts behavioral outcomes based on input features, the method comprising:
receiving, by one or more processors, a historical data set including characteristics of incarcerated individuals and behavioral data for the incarcerated individuals;
extracting, by the one or more processors, feature vectors from the historical data set corresponding to the input features for the behavioral predictive model;
splitting, by the one or more processors, the feature vectors into a training set and a test set;
generating, by the one or more processors, candidate machine-learning models by executing machine-learning algorithms using as input the training set;
calculating, by the one or more processors, a relative accuracy of the behavioral predictive model and the candidate machine-learning models using an error rate for the behavioral predictive model and error rates of the candidate machine-learning models;
determining, by the one or more processors, a drift based on a difference between a feature importance of the input features for the behavioral predictive model and a feature importance of the input features for the candidate machine-learning models; and
in response to the drift exceeding a predetermined drift threshold and/or the relative accuracy being below a predetermined accuracy threshold, generating, by the one or more processors, an alert including the drift and the relative accuracy.

2. The method of claim 1, further comprising labeling, by the one or more processors, a feature included in the feature vectors as a target feature.

3. The method of claim 2, further comprising selecting, by the one or more processors, the machine-learning algorithms based on the target feature.

4. The method of claim 3, wherein selecting the machine-learning algorithms based on the target feature includes applying a mapping of features to algorithms to the target feature to select the machine-learning algorithms.

5. The method of claim 1, further comprising:
calculating, by the one or more processors, the error rate for the behavioral predictive model by executing the behavioral predictive model using as input the test set; and
calculating, by the one or more processors, the error rates for the candidate machine-learning models by executing the candidate machine-learning models using as input the test set.

6. The method of claim 1, further comprising:
determining, by the one or more processors, a feature importance of the input features for the behavioral predictive model; and
determining, by the one or more processors, a feature importance of the input features for the candidate machine-learning models.

7. The method of claim 1, wherein the feature vectors include the input features of the behavioral predictive model and at least one additional feature.

8. The method of claim 7, wherein the alert includes an indication of the feature importance of the at least one additional feature.

9. The method of claim 1, wherein the candidate machine-learning models include one or more of a support vector machine, a decision tree, ensemble trees, a random forest model, a penalized regression model, a generalized additive model, a neural network, a naïve Bayes model, a k-nearest neighbor, a discriminant analysis model, linear regression mode, a non-linear regression model, a generalized linear model, or a gaussian process regression.

10. The method of claim 1, wherein the drift comprises a drift vector including a drift value for each feature in the feature vectors.

11. A non-transitory, computer-readable medium including instructions for automatically detecting data drift in a behavioral predictive model that predicts behavioral outcome based on input features, wherein the instructions, when executed by one or more processors, cause the one or more processors to:
receive a historical data set including characteristics of incarcerated individuals and behavioral outcome data for the incarcerated individuals;
extract feature vectors from the historical data set corresponding to the input features for the behavioral predictive model;
split the feature vectors into a training set and a test set;
generate candidate machine-learning models by executing machine-learning algorithms using as input the training set;
calculate a relative accuracy of the behavioral predictive model and the candidate machine-learning models using an error rate for the behavioral predictive model and error rates of the candidate machine-learning models;
determine a drift based on a difference between a feature importance of the input features for the behavioral predictive model and a feature importance of the input features for the candidate machine-learning models; and
in response to the drift exceeding a predetermined drift threshold and/or the relative accuracy being below a predetermined accuracy threshold, generate an alert including the drift and the relative accuracy.

12. The non-transitory, computer-readable medium of claim 11, wherein the instructions cause the one or more processors to label a feature included in the feature vectors as a target feature.

13. The non-transitory, computer-readable medium of claim 12, wherein the instructions cause the one or more processors to select the machine-learning algorithms based on the target feature.

14. The non-transitory, computer-readable medium of claim 13, wherein the instructions cause the one or more processors to select the machine-learning algorithms based on the target feature by applying a mapping of features to algorithms to the target feature to select the machine-learning algorithms.

15. The non-transitory, computer-readable medium of claim 11, wherein the instructions cause the one or more processors to:
calculate the error rate for the behavioral predictive model by executing the behavioral predictive model using as input the test set; and
calculate the error rates for the candidate machine-learning models by executing the candidate machine-learning models using as input the test set.

16. The non-transitory, computer-readable medium of claim 11, wherein the instructions cause the one or more processors to:
determine a feature importance of the input features for the behavioral predictive model; and
determine a feature importance of the input features for the candidate machine-learning models.

17. The non-transitory, computer-readable medium of claim 11, wherein the feature vectors include the input features of the behavioral predictive model and at least one additional feature.

18. The non-transitory, computer-readable medium of claim 17, wherein the alert includes an indication of the feature importance of the at least one additional feature.

19. The non-transitory, computer-readable medium of claim 11, wherein the candidate machine-learning models include one or more of a support vector machine, a decision tree, ensemble trees, a random forest model, a penalized regression model, a generalized additive model, a neural network, a naïve Bayes model, a k-nearest neighbor, a discriminant analysis model, linear regression mode, a non-linear regression model, a generalized linear model, or a gaussian process regression.

20. The non-transitory, computer-readable medium of claim 11, wherein the drift comprises a drift vector including a drift value for each feature in the feature vectors.
